(19) United States
(12) Patent Application Publication
(10) Pub. No.: US 2014/0099521 A1
(43) Pub. Date: Apr. 10, 2014

(54) SYSTEM AND METHOD FOR MANAGING BATTERY

(71) Applicants: HYUNDAI MOTOR COMPANY, Seoul (KR); KIA MOTORS CORPORATION, Seoul (KR)

(72) Inventors: Jae Woong Kim, Hwaseong (KR); Man Ju Oh, Yongin (KR); Jae Woo Park, Ansan (KR)

(73) Assignees: KIA MOTORS CORPORATION, Seoul (KR); HYUNDAI MOTOR COMPANY, Seoul (KR)

(21) Appl. No.: 13/693,893

(22) Filed: Dec. 4, 2012

(30) Foreign Application Priority Data
Oct. 5, 2012 (KR) 10-2012-0110922

(51) Int. Cl. H01M 10/50

(52) U.S. Cl. CPC H01M 10/5016
USPC 429/50; 429/62

(57) ABSTRACT

Disclosed here is a system for managing a battery including a coolant pump to circulate a coolant through the system, a first cooling channel including a first shutoff valve, configured to circulate the coolant through a radiator and a thermoelectric device, wherein the coolant heats and cools the battery when the battery is overcooled and overcooled; a second cooling channel including a second shutoff valve, connected in parallel with the first cooling channel, wherein the second cooling channel is configured to circulate the coolant through a battery charger; controller configured to determine when a vehicle is parked or being charged, check a temperature of the battery, open and close the first and the second shutoff valve, and control the coolant pump to circulate the coolant through the thermoelectric device, the first cooling channel, and the second cooling channel when the battery is overcooled and overheated.

### CROSS-REFERENCE TO RELATED APPLICATION

This application claims under 35 U.S.C. §119(a) the benefit of Korean Patent Application No. 10-2012-0110922 filed Oct. 5, 2012 the entire contents of which are incorporated herein by reference.

### BACKGROUND

(a) Technical Field

The present invention relates to a system and method for managing a battery while maintaining vehicle performance and durability of a battery by optimally managing the battery temperature in accordance with the status of the battery during vehicle operation.

(b) Background Art

Recently developed environmental vehicles such as hybrid vehicles, electric vehicles, and fuel cell vehicles, use a high-voltage battery as the energy supplier. However, the lifespan of the high-voltage batteries reduces at a high temperature and the amount of available energy rapidly decreases at low temperatures. In general, it is known in the art that the operation efficiency temperature of the high-voltage batteries is about 20° C. to 30° C.

The existing methods for cooling the batteries perform cooling at a high temperature and existing methods for increasing the temperature of batteries is performed using interior cooled air. However the interior air cooling load increases when increasing the temperature of the batteries, thereby limiting the controlling of the battery. In other words, when an interior cooler does not operate, air cooling for the battery is difficult and the interior air cannot be used in many situations when the interior temperature is high. Therefore, there are various problems in cooling or heating a battery, using the interior air, and it is necessary to cool and heat a battery, using a different type of heat source.

Accordingly, although recent developments use a thermoelectric device to cool and heat a battery, fuel efficiency of a vehicle decreases because the device must be supplied with specific power from the battery, and it is difficult to control the temperature of the battery with such a device when the battery is exhausted.

The description provided above as a related art of the present invention is just for helping in understanding the background of the present invention and should not be construed as being included in the related art known by those skilled in the art.

### SUMMARY

The present invention provides a system and method for managing a battery which may use heat from a charger in a vehicle while using a coolant circuit of the vehicle to maintain and manage the operational efficiency temperature of the battery.

The present invention further provides a system for managing a battery (e.g., a battery management system “BMS”) which includes: a first cooling channel that circulates a coolant through a radiator and a thermoelectric device that heats and cools the battery when the battery is overcooled or overcooled; a second cooling channel connected in parallel with the first cooling channel and circulates the coolant through a battery charger; a shutoff valve that controls an opening and closing of the channels at diverging points on the cooling channels; a coolant pump that controls circulation of the coolant; and a controller that controls the shutoff valve and the coolant pump while a vehicle is parked or charged such that the coolant circulates through the thermoelectric device and the first cooling channel or the second cooling channel when the battery is overcooled or overheated.

The controller allows the coolant to circulate through a cooling channel that has a highest temperature, wherein the cooling channel may be the first cooling channel, the second cooling channel, and the thermoelectric device when the battery is overcooled. Additionally, the controller allows the coolant to circulate through a cooling channel that has a lowest temperature among the first cooling channel, the second cooling channel, and the thermoelectric device when the battery is overheated. Furthermore, the controller allows the coolant to circulate through the radiator, the charger, and the thermoelectric device 400, when the battery is overheated and a vehicle is charged.

The thermoelectric device is equipped with a fan blowing toward the battery. The controller controls the coolant pump and the fan to operate at the maximum level when the thermoelectric device breaks down. The controller also controls the radiator including a cooling fan at the maximum level, when the battery is overheated and the thermoelectric device breaks down.

Moreover, a method of managing a battery according to the present invention includes: a determining, by a controller, whether a vehicle is parked or charged; checking, by the controller, the temperature of a battery; and controlling the shutoff valve and the coolant pump to allow the coolant to circulate through the thermoelectric device, the first cooling channel or the second cooling channel when the battery is overcooled or overheated when the vehicle is parked or charged.

In controlling the shutoff valve and the coolant pump, the coolant circulates through a cooling channel that has a higher temperature among the first cooling channel, the second cooling channel, and the thermoelectric device, when the battery is overcooled. Similarly, the coolant circulates through a cooling channel that has a lower temperature among the first cooling channel, the second cooling channel, and the thermoelectric device when the battery is overheated.

The controlling of the shutoff valve and the coolant pump further includes: controlling the shutoff valve to allow the coolant to circulate through the charger and the thermoelectric device, when the battery is overcooled and is charged; and controlling the shutoff valve to allow the coolant to circulate the radiator and the thermoelectric device, when the battery is overheated. Furthermore, the shutoff value and the coolant pump may be controlled so the coolant circulates through the charger and the thermoelectric device when the battery is overheated and a vehicle is charged.

The method of managing the battery further includes a safety step wherein the controller controls the fan disposed toward the battery in the thermoelectric device and the coolant pump at the maximum level, when the thermoelectric device breaks down. Similarly, the controller controls the operation fan, the coolant pump, and the cooling fan in the radiator at the maximum level, when the thermoelectric device breaks down.

Further, a method of managing a battery includes controlling a cooling channel that connects a radiator, a charger, and a thermoelectric device heating and cooling the battery in parallel, wherein a coolant is controlled to circulate through the first cooing channel or the scone cooling channel and the thermoelectric device when the battery is overcooled or overcooled while a vehicle is parked or charged by controlling the shutoff valve and the coolant pump.

### BRIEF DESCRIPTION OF THE DRAWINGS

The above and other features, objects and advantages of the present invention will now be described in detail with reference to exemplary embodiments thereof illustrated the accompanying drawings which are given hereinbelow by way of illustration only, and thus are not limitative of the present invention, and wherein:

FIGS. 1 and 2 are exemplary diagrams illustrating the operation of a system for managing a battery according to an exemplary embodiment of the present invention;

FIG. 3 is an exemplary diagram illustrating the operation of a system for managing a battery according to another exemplary embodiment of the present invention; and

FIG. 4 is an exemplary flowchart illustrating a method of managing a battery according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the term controller refers to a hardware device that includes a memory and a processor. The memory is configured to store the modules/units and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will be made in detail to various embodiments of the present invention, examples of which are illustrated in the accompanying drawings and described below.

A system and method for managing a battery according to an embodiment of the present invention are described hereafter with reference to the accompanying drawings.

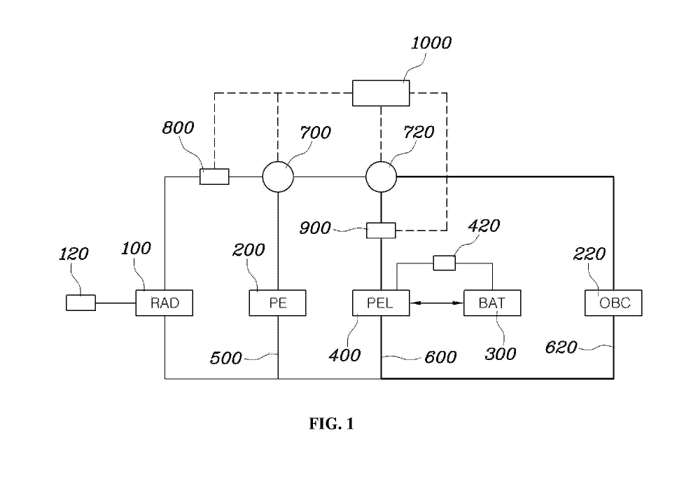

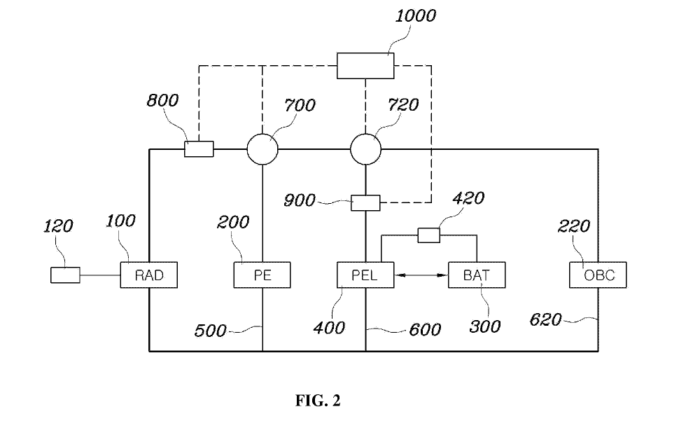

FIGS. 1 and 2 are exemplary diagrams illustrating the operation of a system for managing a battery according to an embodiment of the present invention. The system may include: a coolant pump 600 configured to circulate the coolant through the system, a first cooling channel 600, including a first shutoff valve 700, that may circulate a coolant through a thermoelectric device 400 and a radiator 100 that may heat and cool a battery 300 when the battery 300 is overcooled or overheated; a second cooling channel 620, including a second shutoff valve 720, that may be connected with the first cooling channel 600 in parallel and may circulate the coolant through a charger 220 configured to charge the battery; a controller configured to determine when a vehicle is parked or being charged, check a temperature of the battery, open and close the first and the second shutoff valve 700, 720, and control the coolant pump 900 while the vehicle is parked or being charged to circulate the coolant circulates through the thermoelectric device 400 and the first cooling channel 600 or the second cooling channel 620 when the battery 300 is overcooled or overheated.

In particular, the controller 1000 may allow the coolant to circulate through a cooling channel that has a highest temperature, wherein the cooling channel is selected from the first cooling channel 600, the second cooling channel 620, and the thermoelectric device 400 according to a highest temperature when the battery 300 is overcooled. Additionally, the controller 1000 may allow the coolant to circulate through a cooling channel that has a lowest temperature, wherein the cooling channel is selected from the first cooling channel 600, the second cooling channel 620, and the thermoelectric device 400 when the battery 300 is overheated.

In the system for managing a battery, a cooling circuit may be formed by connecting the radiator 100, the charger 220 (e.g., On Board Charger “OBC”), and the thermoelectric device 400 in parallel. A coolant such as cooling water may flow through the cooling circuit. In particular, the charger 220 refers to a system for charging a battery of a electrical vehicle. Further, the coolant may circulate through an electric power device 200 which may be connected in parallel to an additional cooling channel 500, if necessary. The electric power device 200 may produce heat when a vehicle is driven and thus the first and the second shutoff valve 700, 720 and a pump 800 may be controlled for the coolant to circulate to the electric power device 200 while transferring heat to the battery 300.

Moreover, in the embodiment illustrated in FIG. 1, the shut off valves may be three-way shutoff valves, 700 720 disposed in the thermoelectric device 400. The first and the second shutoff valve 700, 720 may be a solenoid and may implement various channels by opening and closing a plurality of pipes. Further, the coolant pump 900 may be disposed in the first cooling channel 600 of the thermoelectric device 400 and may operate such that a coolant may circulate through the first cooling channel 600.

In particular, the controller 1000 may control the shutoff valves, 700 720 and the coolant pump 900 to form a channel wherein the thermoelectric device 400 heats the battery 300 when the battery is overcooled. Thus, the opposite side to the thermoelectric device 400 may be cooled to apply heat to the battery 300.

Therefore, the controller 1000 may supply the heat from the charger 220 produced while charging a vehicle to the battery 300 through the thermoelectric device 400 by circulating the coolant through the charger 220 and the thermoelectric device 400, as illustrated in FIG. 1. Therefore, it may possible to use the heat from the charger without operating the thermoelectric device 400 by excessively using the battery power, when the battery 300 increases in temperature, thereby conserving energy. As a result, the overcooling of the battery 300 may be prevented during parking of a vehicle.

On the other hand, when the battery 300 is overheated, it may be necessary to cool the battery 300, and the controller 1000 may control the flow of the coolant, as illustrated in FIG. 2, by controlling the first shutoff valve 700 to recover the heat from the battery 300. In other words, the controller 1000 may control the discharge of the heat through the radiator 100 without adding excessive energy into the thermoelectric device 400 by circulating the coolant through the radiator 100 and the thermoelectric device 400. Moreover, since the coolant may accumulate some heat, overheating may be prevented by the circulation of the coolant when the temperature of the battery 300 is substantially low, and it may be possible to more effectively discharge heat by operating a cooling fan 120 of the radiator 100 when the degree of overheating is substantially high. Through this configuration, the cooling of the battery may be performed during a long vehicle operation during high exterior temperatures to ensure a durability of the battery.

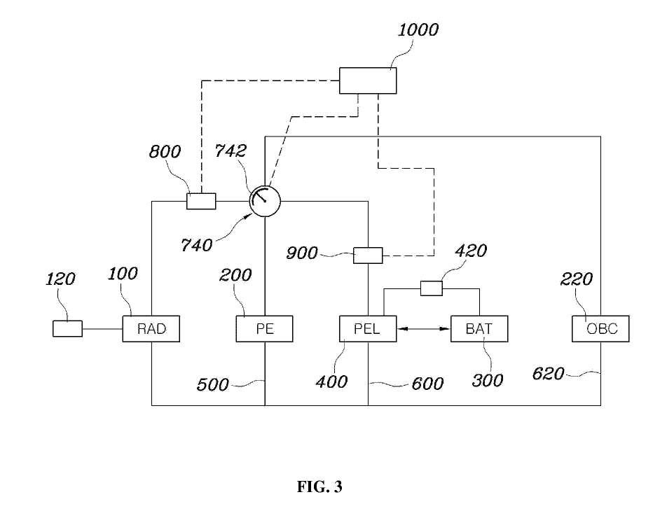

Furthermore, the controller 1000 may control the second shutoff valve 720 to circulate the coolant through the radiator 100, the charger 220, and the thermoelectric device 400, as illustrated in FIG. 3, when the battery 300 and the charger 220 are overheated. In other words, when the battery is heated and charged simultaneously by exterior air, the cooling fan 120 of the radiator 100 may be operated, when the degree of overheating is substantially high. Through this configuration, the charger 220 may be cooled simultaneously while being charged to increase a charging efficiency and ensure safety of the system.

Further, the thermoelectric device 400 may be equipped with a fan 420 disposed toward the battery 300. In other words, one side of the thermoelectric device 400 may be exposed to the interior of the battery 300 and the other side may be exposed to the exterior of the battery 300, so the fan 420 may be disposed for air cooling efficiency when the air inside the battery 300 is cooled through one side of the thermoelectric device 400.

The controller 1000 may control the coolant pump 900 and the fan 420 at a maximum level such that uniform cooling and heating due to heat conduction by the thermoelectric device 400 may be performed, thereby ensuring the battery 300 is properly maintained.

Further, the battery 300 may be cooled by heat conduction when the battery overheats and the thermoelectric device fails since the radiator 100 may be equipped with the cooling fan 120 and the controller 1000 may control the coolant pump 900, the cooling fan 120 and the fan 420 to operate at the maximum level.

FIG. 3 is an exemplary diagram illustrating a system for managing a battery according to an embodiment of the present invention. As illustrated in FIG. 3, a cooling circuit encompassing the power electronics 200 may be configured using one 4-way valve 740, instead of two 3-way valve since various channels may be created through an internal rotary door 742, when using the 4-way valve 740.

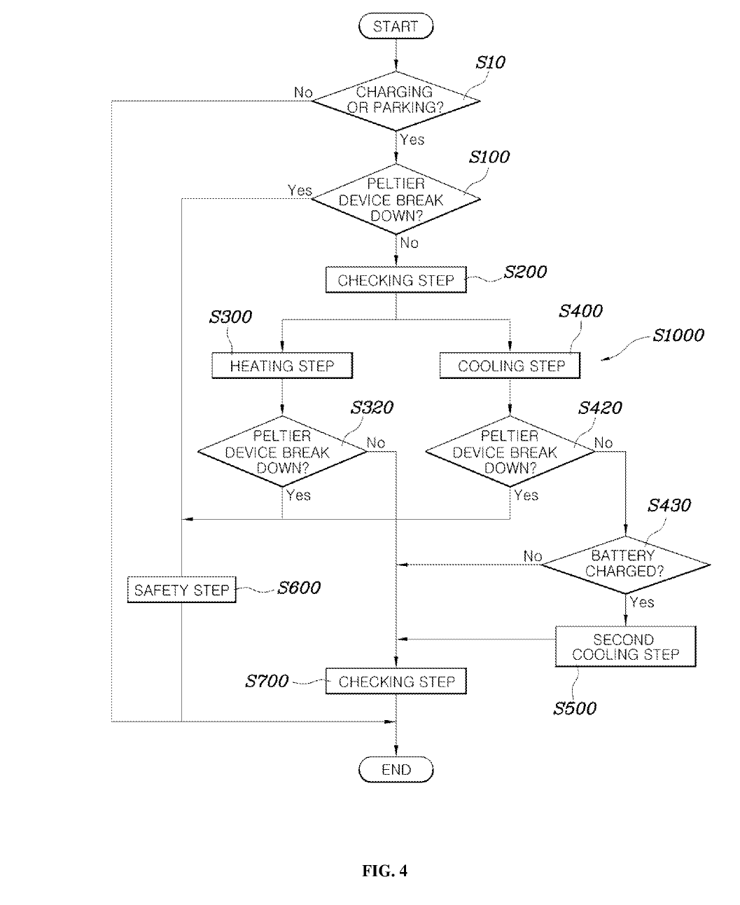

FIG. 4 is an exemplary flowchart illustrating a method of managing a battery according to an embodiment of the present invention. The method may include: determining S10 whether a vehicle is parked or charged; checking S200 the temperature of a battery; and controlling S1000 the shutoff valve and the coolant pump to circulate the coolant through the thermoelectric device, the first cooling channel or the second cooling channel when the battery is overcooled or overheated when the vehicle is parked or charged.

Furthermore, in controlling the shutoff valve and the coolant pump S1000, the coolant may circulate through a cooling channel having a substantially higher temperature, wherein the cooling channel is selected from the first cooling channel, the second cooling channel, and the thermoelectric device, when the battery is overcooled. Additionally, the coolant may circulate through a cooling channel having a substantially lower temperature, wherein the cooling channel is selected from the first cooling channel, the second cooling channel, and the thermoelectric device, when the battery is overheated.

Additionally, controlling S1000 the shutoff valve and the coolant pump may further include: controlling S300 the shutoff valve to circulate the coolant through the charger and the thermoelectric device when the battery is overcooled and is charged; and controlling S400 the shutoff valve to circulate the coolant through the radiator and the thermoelectric device when the battery is overheated.

In other words, in response to determining whether a vehicle is parked or charged, the controller may determine whether the battery may be overheated or overcooled by checking a temperature thereof. Furthermore, the state of the battery may be determined by comparing temperatures to a predetermined temperature range. Additionally, the shutoff valve may be controlled (S300) to circulate the coolant through the charger and the thermoelectric device, when the battery is overcooled and charged. Moreover, when the battery is overheated, the shutoff valve may be controlled (S400) to circulate the coolant the radiator and the thermoelectric device.

Additionally, the shutoff valve may be controlled (S500) such that the coolant circulates through all of the power electrics and the thermoelectric device, when the battery and the power electronics are overheated, by determining whether the power electronics are also overheated S430.

The method further includes controlling the fan S600 disposed toward the battery in the thermoelectric device and the coolant pump at the maximum level, when the thermoelectric device breaks down. This process may further include regulating at various points S100, S320, and S420 whether to control the fan at a maximum level S600. When the thermoelectric device fails, the controller may control the operation fan, the coolant pump, and the cooling fan in the radiator at the maximum level. Moreover, when the temperature of the battery is checked S700 and it is within a substantially normal temperature range, the management is finished.

According to the system and method for managing a battery, which have the configuration described above, it may be possible to manage temperature of a battery in accordance to exterior temperature (e.g., about −30° C. to 50° C.) while a vehicle is parked or charged. Further, when the exterior air is a substantially low temperature, the battery may be pre-heated to increase available energy, thereby increasing potential traveling distance (e.g., about 10% or more). Additionally, when the exterior air is a substantially high temperature, the battery may be pre-cooled to prevent deterioration of a durable lifespan of the battery.

The invention has been described in detail with reference to exemplary embodiments thereof. However, it will be appreciated by those skilled in the art that changes, modifications and variations may be made in these embodiments without departing from the principles and spirit of the invention, the scope of which is defined in the accompanying claims and their equivalents.

What is claimed is:

1. A system for managing a battery comprising:
a coolant pump configured to circulate coolant throughout the system;
a first cooling channel including a first shutoff valve configured to circulate a coolant through a radiator and a thermoelectric device, wherein the coolant heats and cools the battery when the battery is overcooled and overheated;
a second cooling channel including a second shutoff valve connected in parallel with the first cooling channel, wherein the second cooling channel is configured to circulate the coolant through a battery charger; and
a controller configured to:
determine when a vehicle is parked or being charged;
check a temperature of the battery;
open and close the first and the second shutoff valve; and
control a coolant pump when a vehicle is parked or being charged and the battery is overcooled or overheated.

2. The system of claim 1, wherein the controller is configured to circulate the coolant through a cooling channel that has a highest temperature when the battery is overcooled, wherein the cooling channel is selected from a group consisting of: the first cooling channel, the second cooling channel, and the thermoelectric device.

3. The system of claim 1, wherein the controller is configured to circulate the coolant through a cooling channel that has a lowest temperature when the battery is overheated, wherein the cooling channel is selected from a group consisting of: the first cooling channel and the second cooling channel, and the thermoelectric device.

4. The system of claim 1, wherein the controller is configured to circulate the coolant through the radiator, the charger, and the thermoelectric device when the battery is overheated and the vehicle is being charged.

5. The system of claim 1, wherein the thermoelectric device includes a fan disposed toward the battery.

6. The system of claim 5, wherein the fan is controlled by the controller to operate with the coolant pump at a maximum level, when the thermoelectric device fails.

7. The system of claim 1, wherein the radiator includes a cooling fan operated with the coolant pump by the controller at the maximum level, when the battery is overheated and the thermoelectric device fails.

8. A method of managing a battery comprising:
determining, by a controller, when a vehicle is parked or being charged;
checking, by the controller, a temperature of the battery;
opening and closing, by the controller, a shutoff valve of a first and a second cooling channel at a plurality of diverging points of the first and the second cooling channel; and
controlling, by the controller, a coolant pump to circulate a coolant through the first cooling channel, the second cooling channel, and a thermoelectric device when the vehicle is parked or being charged and the battery is overcooled and overheated

9. The method of claim 8, further comprising circulating, by the controller, the coolant through a cooling channel that has a highest temperature when the battery is overcooled, wherein the cooling channel is selected from a group consisting of: the first cooling channel, the second cooling channel, and the thermoelectric device.

10. The method of claim 8, further comprising circulating, by the controller, the coolant through the cooling channel that has a lowest temperature when the battery is overheated, wherein the cooling channel is selected from a group consisting of: the first cooling channel and the second cooling channel, and the thermoelectric device.

11. The method of claim 8, wherein circulating the coolant further includes:
controlling, by the controller, the shutoff valve to circulate the coolant through a charger and the thermoelectric device, when the battery is overcooled and charged; and
controlling, by the controller, the shutoff valve to circulate the coolant through a radiator and the thermoelectric device, when the battery is overheated.

12. The method of claim 11, wherein circulating, by the controller, the coolant further comprises controlling the shutoff valve to circulate the coolant through the charger and the thermoelectric device, when the battery is overheated and the vehicle is charged.

13. The method of claim 11, further comprising controlling, by the controller, a fan disposed toward the battery in the thermoelectric device and the coolant pump at a maximum level, in response to the thermoelectric device failing.

14. The method of claim 13, wherein controller controls the fan, the coolant pump, and the cooling fan in the radiator at the maximum level in response to the thermoelectric device failing.
